(19) United States
(12) Patent Application Publication
(10) Pub. No.: US 2009/0044759 A1
(43) Pub. Date: Feb. 19, 2009

(54) Fence panel for a horse training corral

(76) Inventor: Daniel Lewis, Julian, CA (US)

Correspondence Address: CALIF KIP TERVO, 6387 CAMINITO LAZARO, SAN DIEGO, CA, 92111, US

(21) Appl. No.: 11/893,795

(22) Filed: Aug. 17, 2007

(51) Int. Cl. A01K 29/00

(52) U.S. Cl. 119/502

(57) ABSTRACT

A fence panel for a horse training corral generally comprises a containment wall for containing a horse and a dog-leg support member connected to the bottom of the containment wall for supporting the containment wall at a height so as to contain a horse and extending substantially outward from the wall such that a horse confined inside the fence panel is substantially prevented from striking the bottom of the dog-leg support member with a hoof. A horse training corral includes a plurality of joined of fence panels wherein the second end member of one panel is joined to the first end member of an adjoining panel. Preferably, the dog leg support members extend laterally so as to align with the corral center. A plurality of ground footers each include bosses for receiving a dog-leg from each of adjacent joined the panels.

### FIELD OF THE INVENTION

This invention relates generally to fencing for horse corrals, and more specifically involves fencing for a horse training corral.

### BACKGROUND OF THE INVENTION

Typically, horses are trained in a training corral wherein the trainer is positioned near the middle of the corral and the horse moves on a lead around the trainer. The horse is taught correct leads, and develops optimum bend, collection, and balance.

Round corrals are generally preferred over square corrals for training. A horse tends to lose focus in the corners of a square corral, whereas in a round corral the horse remains substantially an equal distance from the containment wall and the trainer.

Prior art corrals, even round corrals, suffer from several shortcomings.

FIG. 1 is a top, inner side, perspective view of a common prior art fence panel 110. FIG. 2 is an end elevation view of the prior art fence panel 110 of FIG. 1 further including the ground 90 and a horse 95 training inside the fence 110. A plurality of fence panels 110 are joined to make a round corral.

Prior art fence panel 110 includes upright posts 120, such as first post 120F and second posts 120S, and plurality of horizontal rails 130 joining posts 120. Posts 120 are straight and include a lower portion 125 that is supported by the ground 90 such that fence 110 is vertical. Horse 95, tethered to lead 99, is moving adjacent fence 110. Because horse 95 occasionally or often hits a hoof 97 on lower portion 125 of post 120, horse 95 drops a front shoulder and leans away from fence 110. Consequently, horse 95 learns an awkward position that must later be unlearned. Also, because of this unnatural position of horse 95, horse 95 cuts an inwardly slanted groove 93 in ground 90. Groove 93 then causes problems with future maneuvering of this horse or other horses. It is difficult to smooth out grove 93 by conventional dragging methods because the drag also will strike lower portion 125 of post 120.

Thus there has been a need for an improved fence for a horse training corral that overcomes the shortcomings of the prior art.

### SUMMARY OF THE INVENTION

According to a first aspect of the invention, a fence panel for a horse training corral generally comprises a containment wall for containing a horse and a dog-leg support member connected to the bottom of the containment wall for supporting the containment wall at a height so as to contain a horse and extending substantially outward from the wall such that a horse confined inside the fence panel is substantially prevented from striking the bottom of the dog-leg support member with a hoof. In the exemplary embodiment, the containment wall includes spaced first and second upright end members joined by a plurality of rails, and a dog-leg support member connects to each end member.

A horse training corral includes a plurality of joined fence panels wherein the second end member of one panel is joined to the first end member of an adjoining panel. Preferably, the dog leg support members extend laterally so as to align with the corral center. A plurality of ground footers each include bosses for receiving a dog-leg from each of adjacent joined panels.

The features and advantages of the invention will be readily understood when the detailed description thereof is read in conjunction with the accompanying drawings wherein like reference numerals refer to like parts throughout.

### BRIEF DESCRIPTION OF THE DRAWINGS

FIG. 1 is a top, inner side, perspective view of a common prior art fence panel.

FIG. 2 is an end elevation view of the prior art fence panel of FIG. 1 further including the ground and a horse training inside the fence.

FIG. 3 is a top, inner side, perspective view of an exemplary embodiment of the fence panel of the invention.

FIG. 4 is an end elevation view of the exemplary fence panel of FIG. 3 further including the ground and a horse training inside the fence.

FIG. 5 is an enlarged, partial, inner side, elevation view of the left end of the fence panel of FIG. 3.

FIG. 6 is an example of a plurality of the fence panels of FIG. 3 arranged into a training corral.

FIG. 7 is a partial, top plan view of the fence panel of FIG. 6 further joined to a similar fence panel and including a ground footer.

FIG. 8 is a perspective view of the ground footer of FIG. 7.

FIG. 9 is a joining assembly for joining two upright members.

FIG. 10 is an alternate embodiment of the support member for the fence panel.

### DETAILED DESCRIPTION OF THE INVENTION

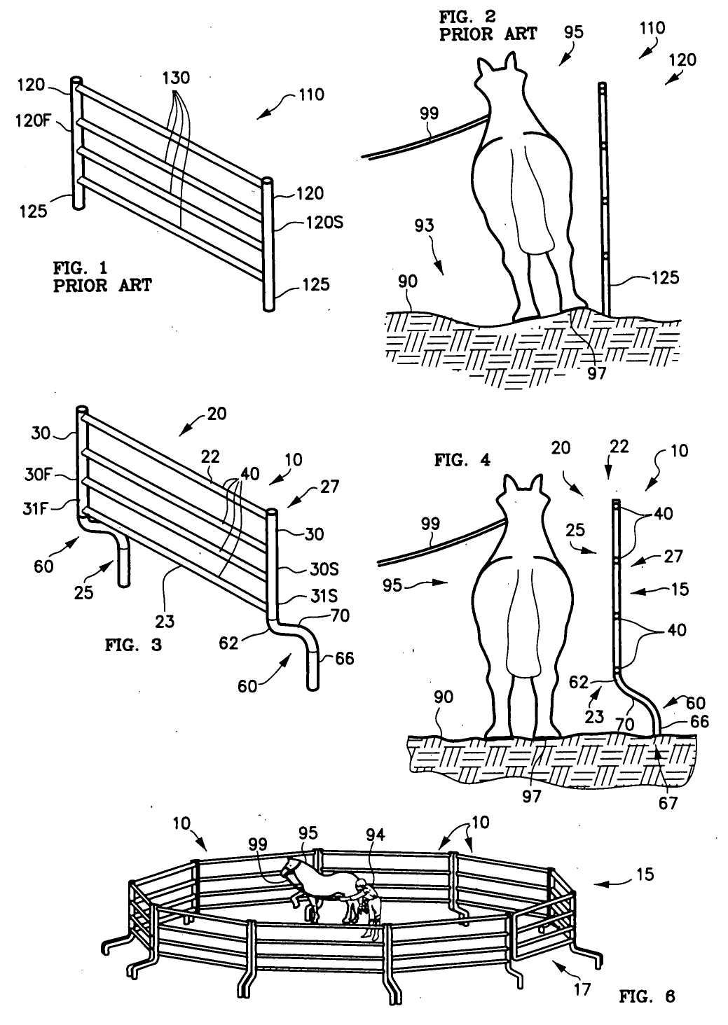

With reference now to the drawings, and more particularly to FIGS. 3-6 thereof, there is shown in FIG. 3 a top, inner side, perspective view of an exemplary embodiment of the fence panel 10 of the invention, in FIG. 4 an end elevation view of exemplary fence panel 10 of FIG. 3 further including the ground 90 and a horse 95 training inside fence 10, in FIG. 5 an enlarged, partial, inner side, elevation view of the left end of fence panel 10 of FIG. 3, and in FIG. 6 an example of a plurality of fence panels 10 of FIG. 3 arranged into a training corral 15. Trainer 94 stands near center of corral 15 and tethers horse 95 on lead 99.

Fence panel 10 generally comprises a containment wall 20 for containing horse 95 and one or more dog-leg support members 60 for supporting containment wall 20 at a height so as to contain horse 95. Exemplary containment wall 20 comprises a plurality of upright support members 30, such as first upright member 30F, such as first post 31F, a second upright member 30S, such as second post 31S laterally spaced from first post 30F, and a plurality of rails 40 joining first post 31F and second post 31S so as to confine horse 95. Rails 40 include top rail 40T, interior rails 401 and bottom rail 40B. Containment wall 20 defines a plane. Containment wall 20 has a top 22, a bottom 23; a first end 34, a second end 37, an inner side 25 and an outer side 27.

Upright members 30 may typically consist of a round, tubular post made of heavy-walled pipe. Rails 40 may be made of similar or slightly smaller pipe material. All could be joined together by any desirable means, such as by welding. Although four horizontal rails 40 are shown, other numbers of rails with other orientations will fall within the concept of the invention. Typically, size for wall 20 is a length of 10′-12′ and a height of 40″-52″ so that each panel 10 can be moved and manipulated by an assembler.

Dog-leg support member 60 includes a top portion 62 connected to bottom 23 of containment wall 20 for supporting containment wall 20 at a height so as to contain horse 95, a bottom portion 66 for being supported by ground 90, and a mid-section 70 connecting top portion 62 and bottom portion 66 and extending substantially immediately outward from top portion 62 such than bottom portion 66 is displaced outward such that horse 95 confined inside fence 10 is substantially prevented from striking bottom portion 66 with hoof 97. In the exemplary embodiment, mid-section is directed outward at about 60 degrees for 14 inches and then downward so as to place bottom portion 66 about 12 inches outward from wall 20. Bottom portion 66 is about 14 inches in length such that bottom 23 of wall 20 is about 21 inches from ground 90. In the embodiment of FIGS. 3-5, dog-leg support 60 is simply an extended lower portion of each post 31F, 31S that is bent as described. Preferably, bottom 23 of wall 20 is supported by dog-leg support member 60 at about 20-26 inches above ground 90 so as to contain horse 95. The supported top 22 of containment wall 20 is typically around 5′-6′ above ground 90.

As seen in FIG. 4, horse 95 on lead 99 moving adjacent fence 10 is not afraid of striking hoof 97 on lower portion 66 of support 60 and thus stands erect, does not lean inward, and does not create an inward sloping trough 93 in ground 90. A drag tool can extend under containment wall 20 to smooth out ground 90 when it becomes rough or when new soil is added to ground 90 in corral 15.

As seen in FIGS. 5-7 and best seen in FIG. 7 which is a partial, top plan view of fence panel 10 of FIG. 5 further joined to a similar fence panel 10B and including a ground footer 80, in the exemplary embodiment, bottom portion 66 of dog-leg support member 60 is not only displaced outward from containment wall 20 but also laterally through an angle R so as to be radial to round corral 15 such that, when joined in round corral 15, dog-leg support members 60 of adjacent panels 10 are adjacent one another. Second dog-leg support member 60S of fence panel 10B is adjacent first dog-leg support member 60F of fence panel 10A. Each dog-support member 60 is displaced laterally an angle R from being normal to wall 20. The sine of angle R is one-half the length of fence panel 10 divided by the radius of corral 15 to the junction of fence panels 10. The tangent of angle R is one-half the length of panel 10 divided by the effective radius of round corral 15; the effective radius being the radius to the closest inner side 25 of fence panel 10. With a radius in the range of 25′-30′ and a panel length of 10′-12′, angle R is typically in the range of 11-12 degrees.

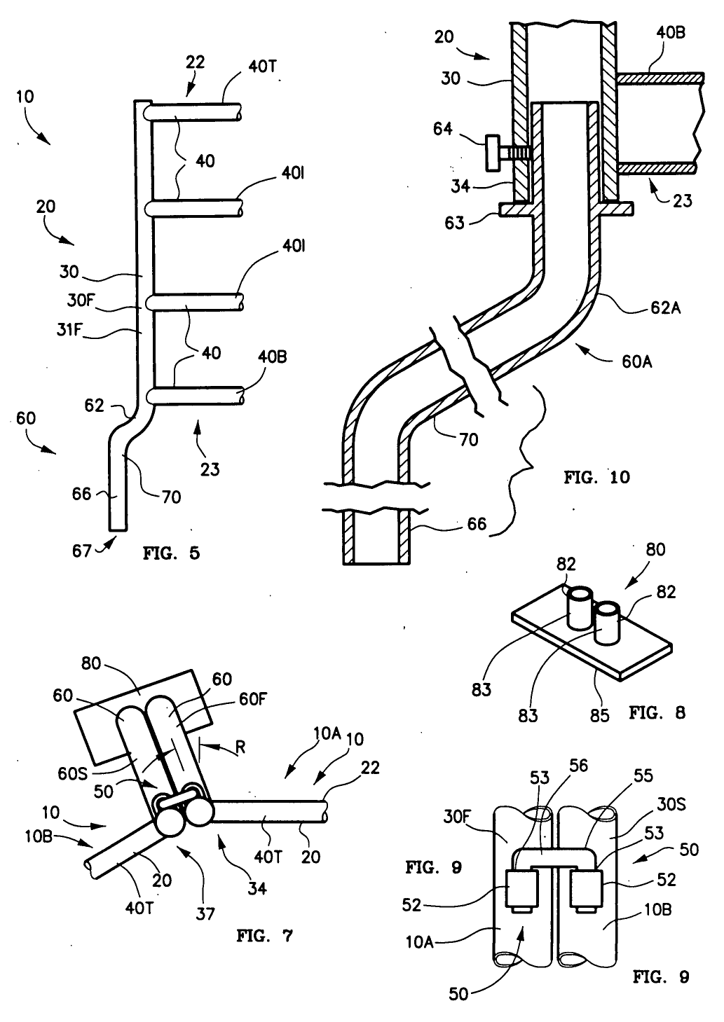

FIG. 8 is a perspective view of ground footer 80 of FIG. 7. Ground footer 80 includes a base plate 85 and mounting means 82, such as one or two bosses or collars 83, each for mounting bottom portion 66 of dog-leg support member 60 to base plate 85. Protrusions or bosses 83 that go inside bottom end 67 of dog-leg 60 or collars that surround dog-leg 60 retain bottom portion 66 of dog-leg 60 in position on base plate 85, thus holding adjacent panels 10 in position. Base plate 85 distributes the load over a larger area of ground 90 such that dog-legs 60 do not sink into softer ground 90.

FIG. 9 is an exemplary embodiment of a joining assembly 50 for joining two upright members 30F, 30S. Joining assembly 50 can also be seen in FIG. 7. Joining assembly 50 holds adjacent upright members 30 together to form corral 15. First upright member 30F from panel 10A and second upright member 30S from adjacent panel 10B each include a side fixture, such as eye fixtures 52, each having a upward facing orifice 53 for receiving a connecting pin 55, such as U-shaped pin 56, for holding adjacent upright members 30S, 30F together. Each upright member 30 may have one or more joining assemblies 50 thereon.

FIG. 10 is an alternative embodiment 60A of dog-leg support member 60 for the fence panel 10, such as attachable dog-leg 60A. Attachable dog-leg 60A is similar to dog-leg 60 of FIG. 3 and includes a bottom portion 66 and mid-section 70; however top portion 62A is adapted to attach to bottom 23 of wall 20, such as to bottom 34 of upright member 30. In the exemplary embodiment shown, bottom 34 of upright member 30 is a hollow cylinder and top portion 62A is inserted therein. Support means, such as a pin, not shown, through upright member 30 and top portion 62A or flange 63 on top portion 62A support upright member 30 on dog-leg 62A supports wall 20 on dog-leg 60A. Dog-leg 60A may be pivoted, such as through angle R, to align with the dog-leg 60 of an adjacent panel 10. Means, such as a pin or set screw 64, is provided for attaching dog-leg 60A to wall 20 and for retaining dog-leg 60A at a given angle of rotation relative to wall 20.

Returning to FIG. 6 showing a round training corral 15 made of a plurality of the fence panels 10 of FIG. 3, a gate 17 may comprise a wall 20 hinged to an adjacent panel 10 on one end and selectively attachable to an adjacent panel 10 on the other end. Panels 10 are easily moved and erected. Typically, once two or more panels 10 are connected together they form a free-standing arch such that no posts need to driven into the ground for support during construction of corral 15.

Having described the invention, it can be appreciated that it provides a means for better training a horse or other riding animal. The dog-leg supports 60 allow ground work, such as dragging, to be done under the containment wall 20 to keep the ground 90 flat adjacent the wall 20 which helps keep the horse's shoulders level for a surer footed and well balanced horse.

Although a particular embodiment of the invention has been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

The word “horse” in the appended claims is used for clarity for focusing on the general subject matter but is not intended to be so limiting and is intended to cover other similar animals, such as llamas and camels, which may be trained in a similar manner.

I claim:

1. A fence panel for a horse training corral comprising:
a containment wall for containing a horse; said containment wall having a top, a bottom; an inner side and an outer side; and
a dog-leg support member including:
a top portion connected to said bottom of said containment wall for supporting said containment wall at a height so as to contain a horse;
a bottom portion for being supported by the ground; and
a mid-section connecting said top portion and said bottom portion and extending substantially immediately outward from said top portion such than said bottom portion is displaced outward such that a horse confined inside said fence panel is substantially prevented from striking said bottom portion with a hoof.

2. The fence panel for a horse training corral of claim 1 wherein:
said containment wall defines a plane.

3. The fence panel for a horse training corral of claim 1 wherein:
said mid-section, connecting said top portion and said bottom portion, extends substantially immediately outward from said top portion.

4. The fence panel for a horse training corral of claim 1 wherein:
said dog-leg support member extends laterally so as to align with a corral center when a plurality of said fence panels are joined to form a corral.

5. The fence panel for a horse training corral of claim 1 wherein:
said dog-leg support member is selectively attachable to said wall.

6. The fence panel for a horse training corral of claim 5 wherein:
said dog-leg support member is selectively rotatable relative to said wall.

7. The fence panel for a horse training corral of claim 1 including:
a plurality of said dog-leg support members.

8. The fence panel for a horse training corral of claim 7 wherein:
said plurality of dog-leg support member extends laterally such that each aligns with a radius from a corral center when a plurality of said fence panels are joined in a corral.

9. A fence panel for a horse training corral comprising:
a containment wall for containing a horse comprising:
a first upright member;
a second upright member laterally spaced from said first upright member; and
a plurality of rails joining said first upright member and said second upright member so as to confine a horse; said containment wall defining a plane; said containment wall having a top, a bottom; an inner side and an outer side; and
a dog-leg support member including:
a top portion connected to said bottom of said containment wall for supporting said containment wall at a height so as to contain a horse;
a bottom portion for being supported by the ground; and
a mid-section connecting said top portion and said bottom portion and extending substantially immediately outward from said top portion such than said bottom portion is displaced outward such that a horse confined inside said fence is substantially prevented from striking said bottom portion with a hoof.

10. The fence panel for a horse training corral of claim 9 wherein:
said dog leg support member extends laterally so as to align with a corral center when a plurality of said fence panels are joined to form a corral.

11. The fence panel for a horse training corral of claim 9 including:
a plurality of said dog-leg support members including:
a first dog-leg support member attached to said first upright member; and
a second dog-leg support member attached to said second upright member.

12. The fence panel for a horse training corral of claim 11 wherein:
said first dog-leg support member is selectively attachable to said first upright member; and
said second dog-leg support member is selectively attachable to said second upright member.

13. The fence panel for a horse training corral of claim 12 wherein:
said first dog-leg support member is selectively rotatable relative to said wall.

14. A horse training corral including:
a plurality of joined fence panels; each fence panel comprising:,
a containment wall for containing a horse; said containment wall having a top, a bottom; a first end, a second end, an inner side and an outer side; and
a dog-leg support member including:
a top portion connected to said bottom of said containment wall for supporting said containment wall at a height so as to contain a horse;
a bottom portion for being supported by the ground; and
a mid-section connecting said top portion and said bottom portion and extending outward from said top portion such than said bottom portion is displaced outward such that a horse confined inside said fence panel is substantially prevented from striking said bottom portion with a hoof.

15. The horse training corral of claim 14 wherein:
said dog leg support member extends laterally so as to align with the corral center.

16. The horse training corral of claim 14 wherein each said panel includes:
a plurality of said dog-leg support members.

17. The horse training corral of claim 16 wherein:
said plurality of dog-leg support member extend laterally so as to align with the corral center.

18. The horse training corral of claim 17 further including:
a plurality of ground footers; each ground footer including:
dog-leg leg receiving means for receiving a dog-leg from each of adjacent joined said panels.

19. The fence panel for a horse training corral of claim 14 wherein:
said containment wall defines a plane.

20. The fence panel for a horse training corral of claim 14 wherein:
said mid-section, connecting said top portion and said bottom portion, extends substantially immediately outward from said top portion.
